(19) United States
(12) Patent Application Publication
(10) Pub. No.: US 2006/0253791 A1
(43) Pub. Date: Nov. 9, 2006

(54) Simplified interactive graphical user interfaces for sorting through a stack of overlapping windows on a display in order along the Z (depth) axis

(76) Inventors: David P. Kuiken, Round Rock, TX (US); Walter Lee, Cedar Park, TX (US); Mark D. Rogalski, Leander, TX (US)

Correspondence Address: IBM CORPORATION;INTELLECTUAL PROPERTY LAW, 11400 BURNET ROAD, AUSTIN, TX, 78758, US

(21) Appl. No.: 11/120,905

(22) Filed: May 3, 2005

(51) Int. Cl. G06F 17/00; G06F 9/00

(52) U.S. Cl. 715/766; 715/802; 715/794; 715/797

(57) ABSTRACT

An implementation to simplify GUI display interfaces having stacks of overlapping windows by enabling an interactive user to sort through the stacks of windows in a user friendly intuitive manner without resizing or moving any of the windows in the stack. A computer controlled interactive display system includes a stored hierarchy of windows that are displayable to overlap each other in a selected order to form a displayed stack of windows along the depth (Z) axis. An implementation for designating a starting window in said stack, and for displaying this starting window in focus. Then, scrolling along said Z axis from this starting window to thereby sequentially display subsequent windows in the stack in the selected order. After each of the sequentially displayed windows, an implementation for fading the starting or currently displayed window out of focus and after each fading out of the currently displayed window, for then bringing the next subsequent window into displayed focus.

### TECHNICAL FIELD

The present invention relates to user interactive computer supported display technology and particularly to windows-type graphical user interfaces crowded with a variety of windows, often in stacks of overlapped windows.

### BACKGROUND OF RELATED ART

The past decade has been marked by a technological revolution driven by the convergence of the data processing industry with the consumer electronics industry. This advance has been even further accelerated by the extensive consumer and business involvement in the Internet or World Wide Web (Web) (used interchangeably). As a result of these changes, it seems as if virtually all aspects of human endeavor in the industrialized world require human-computer interfaces. There is a need to make computer directed activities accessible to a substantial portion of the world's population, which, up to a few years ago, was computer indifferent. In order for the vast computer supported marketplaces to continue and be commercially productive, it will be necessary for a large segment of computer indifferent consumers to be involved in computer interfaces.

With the increasing power of computers, functions and resources available to the interactive user have greatly increased. However, along with this increase in function has come a significant increase in the number and variety of windows available to the user in a display screen interface. This, of course, makes the interface much more complex with dozens of available windows that contain the interactive data items, such as icons. These are arranged in stacks of overlapping windows, the display of which is controlled and tracked through a multi-tiered display or frame buffer, such as the depth buffers described in U.S. Pat. No. 5,241,656.

In fact, the multi-tiered hierarchy of windows has become so extensive that they often are arranged in a plurality of desktop session levels. A desktop session is usually made up of several layers of overlapping windows that the depth frame buffer indexes and tracks. In addition, window interfaces are set up to handle additional desktop sessions of layered windows that are inactive and stored outside of the frame buffer, but may be interactively moved into and out of the frame buffer as the sessions are activated. With such a complex arrangement, it will be obvious that at any given time a desktop display interface will present a confusion of many windows, particularly to users with limited computer experience.

When windowing environments were originally developed, the interactive user had to deal with no more than a handful of windows. From that time on, it became customary to identify each window with a title bar including the name or title of the window. With so few windows, even if there was some overlap, it was simple for the user to shift a window with his cursor so as to expose the title bar and identify the window. At the present time, with the number and the complicated hierarchies of windows described above, it is often a tedious and difficult task for the user to shift or drag the displayed windows to expose enough of the title bars or even other portions of windows sufficient to identify partially covered windows that are active.

Needless to say, there have been many schemes made available for helping the interactive user to sort through the variety of windows on display stacks, and to select the window that the user needs to work with. Many of the current schemes for sorting and locating windows in the stack involve searching of lists of windows or of icons representative of the windows. Other schemes involve moving or resizing windows.

### SUMMARY OF THE PRESENT INVENTION

The present invention offers an implementation to simplify GUI display interfaces having stacks of overlapping windows by enabling an interactive user to sort through the stacks of windows in a user friendly intuitive manner without resizing or moving any of the windows in the stack.

The present invention relates to a computer controlled interactive display system comprising a stored hierarchy of windows that are displayable to overlap each other in a selected order to form a displayed stack of windows along the depth (Z) axis. The invention provides a simple intuitive system enabling an interactive user to sort through the stack of windows in order along the Z axis through the combination of means for designating a starting window in said stack, and means for displaying this starting window in focus. Then, there are means for scrolling along said Z axis from this starting window to thereby sequentially display subsequent windows in the stack in the selected order. The invention provides means after each of the sequentially displayed windows for fading the starting or currently displayed window out of focus and means, after each of the means for fading the currently displayed window, for then bringing the next subsequent window into displayed focus. While the scrolling along the Z Axis may be in either up or down, the preferable and most commonly used expedient is downward from the starting or current window.

The system of the present invention may be implemented by a computer mouse for controlling a displayed pointer, which may designate the starting window by pointing to the window. The system also provides the user with means enabling the user to vary the rates of fading said windows out of focus and bringing subsequent windows into focus. This enabling means may be implemented as a manually controlled input on the computer mouse, such as a scroll wheel, for example.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit that is capable of implementing the sorting of the stack of windows of the present invention;

FIG. 2 is a diagrammatic view of a display screen showing an illustrative stack of windows to be sorted in accordance with the present invention;

FIG. 3 is the display screen of FIG. 2, after the starting window in the stack has been designated;

FIG. 4 is the display screen of FIG. 3, after the stack of windows has been scrolled downward along the Z axis so that the designated starting window has been scrolled to fade out of focus while the next subsequent window in the stack along the Z axis has not as yet been brought into focus;

FIG. 5 is the display screen of FIG. 4 after the scrolling along the Z axis in the stack has reached the next subsequent window and brought this window into focus;

FIG. 6 is a flowchart of the program steps involved in setting up the interactive window stack sorting system of the present invention; and

FIG. 7 is a flowchart of an illustrative running of the steps set up in the program of FIG. 6.

### DETAILED DESCRIPTION OF THE PREFERRED EMBODIMENT

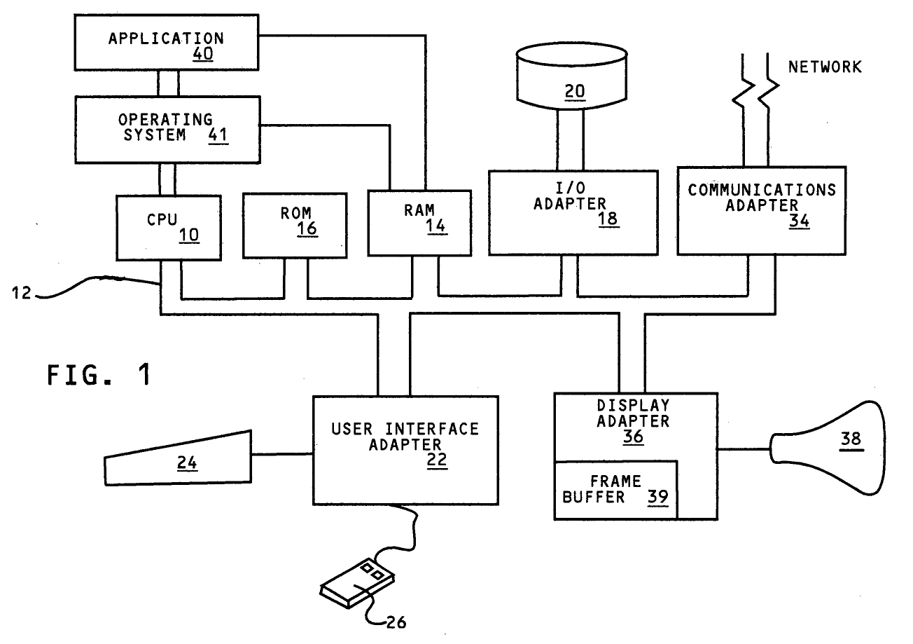

Referring to FIG. 1, a typical data processing system is shown that may function as the computer controlled display terminal used to display the stack of windows and in implementing the system of the present invention of sorting the stack of windows by scrolling downward along the Z axis to fade currently displayed windows out of focus and to bring the next subsequent window into focus. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the programs of the present invention for sorting through a stack of displayed windows by scrolling downward along the Z axis to fade currently displayed windows out of focus and to bring the next subsequent window into focus that will be described hereinafter in greater detail. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39 that is a storage device that holds a representation of each pixel on the display screen 38. Images may be stored in frame buffer 39 for display on monitor 38 through various components, such as a digital to analog converter (not shown) for CRTs and the like for digital displays, e.g. LCD displays. As previously mentioned, in order to accommodate the hierarchies of overlapping and hidden windows, the frame buffer 39 should be a depth buffer (for example the depth buffer of U.S. Pat. No. 5,241,565). By using the aforementioned I/O devices, a user is capable of inputting information to the system through the keyboard 24 or mouse 26 and receiving output information from the system via display 38. Mouse 26 has a scroll wheel 25 that will be used by the interactive user to scroll down through the stack of windows along the Z axis to bring the desired window in the stack into focus.

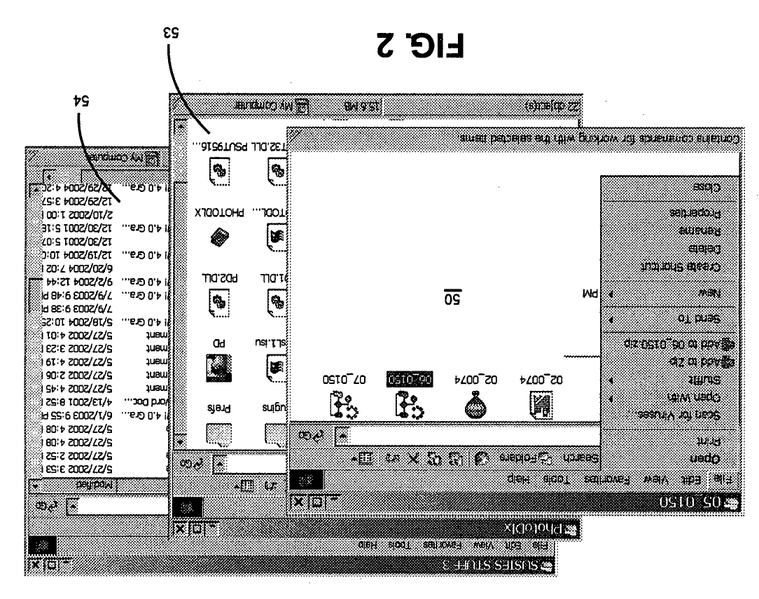

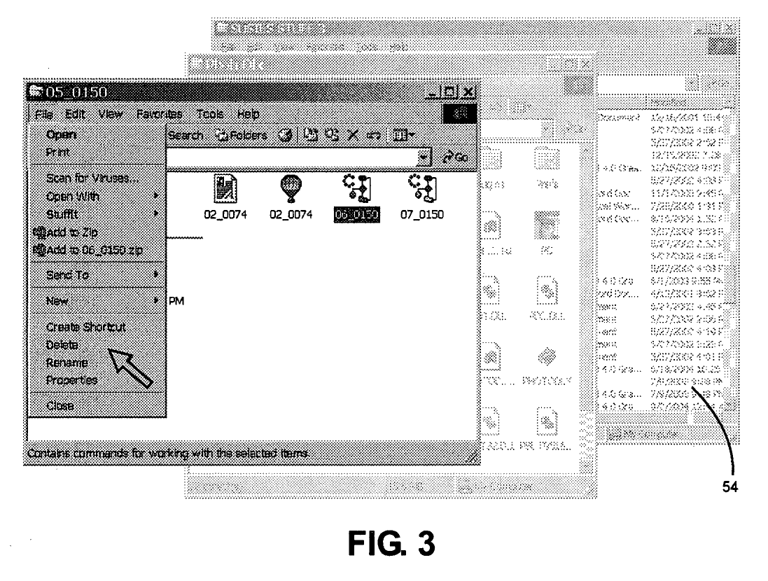

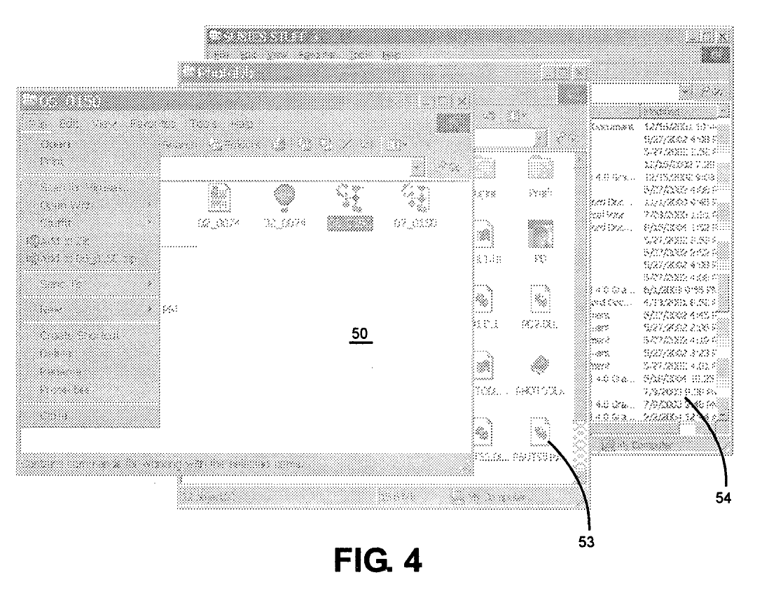

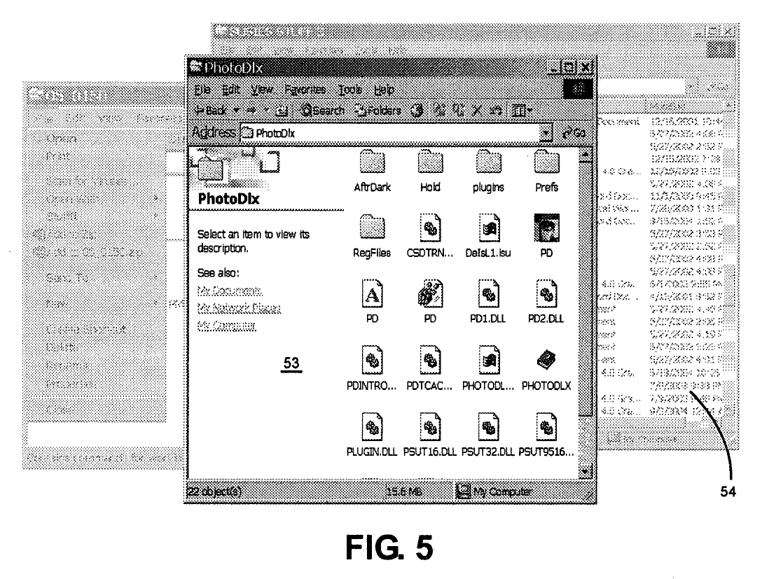

There will now be described a simple illustration of the present invention with respect to the display screens of FIGS. 2 through 5. A series of comparative figures illustrate an embodiment of the invention. The display interface has been simplified in FIG. 2 for purpose of illustration to show just three windows 50, 53 and 54 of the multitude of windows usually in a stack in such a GUI interface. In FIG. 2, the stack of windows is conventionally shown. Now, in accordance with the present invention when the user is to scroll down the stack, cursor or pointer 51 is moved into the selected starting window and clicked on by a pointer, e.g. a mouse pointer to so designate window 50, as shown in FIG. 3. This may also be done by an appropriate key on a keyboard. When this occurs, the other windows, e.g. 53 and 54, lower in the stack fade out of focus. Then, as illustrated in FIG. 4, as the stack of windows is scrolled down along the Z axis to an intermediate point where window 50 has faded out of focus but the next lower window has not been reached, i.e. been brought into focus so that windows 50, 53 and 54 are all out of focus. Finally, the next lower window 53 has been brought into focus as shown in FIG. 5 and the starting window 50 has become transparent, completely faded out.

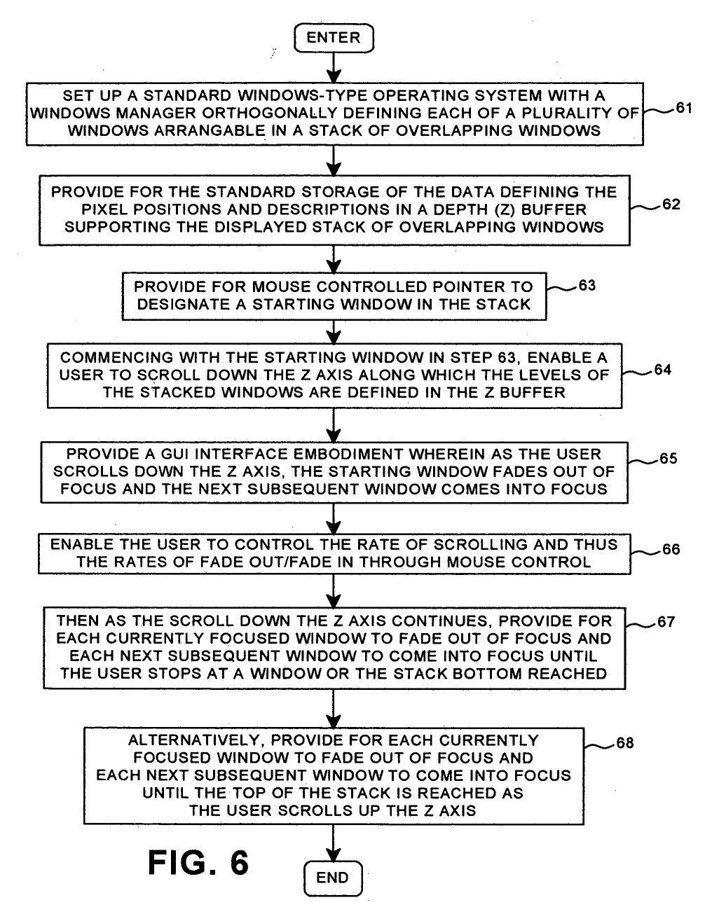

Now, with reference to FIG. 6, we will describe a process implemented by a program according to the present invention for sorting through a stack of displayed windows by scrolling downward along the Z axis to fade currently displayed windows out of focus and to bring the next subsequent window into focus. A basic type of operating system is set up, step 61, using any operating system for managing a hierarchy of windows, e.g. Windows Millennium™, and Motif for Unix or AIX to orthogonally define the overlapping windows in the stack and the positions of the windows in the depth levels of the hierarchy. This is accomplished by standard storage of data defining the pixel descriptions and orthogonal positions in a depth or Z-buffer to support a stack of overlapping windows, step 62. Provision is made enabling a user through the mouse pointer to designate a starting window in the stack, step 63. The user is enabled to, commencing with the starting window to scroll down the Z axis along which the levels of stacked windows are defined in the Z buffer, step 64. A GUI interface embodiment is provided wherein as the users scrolls down the Z axis, the starting window fades out of focus and the next subsequent window comes into focus, step 65. The user is enabled to control the rate of scrolling and thus the rates of fade out/fade in through mouse control, step 66. Then, as the scroll down the Z axis continues, provision is made for each currently focused window to fade out of focus, and each next subsequent window to come into focus until the user stops at a window or the stack bottom is reached, step 67. Alternately, provision may be made for the currently focused window to fade out of focus, and each next subsequent window to come into focus until the user stops at a window or the stack top is reached, step 68.

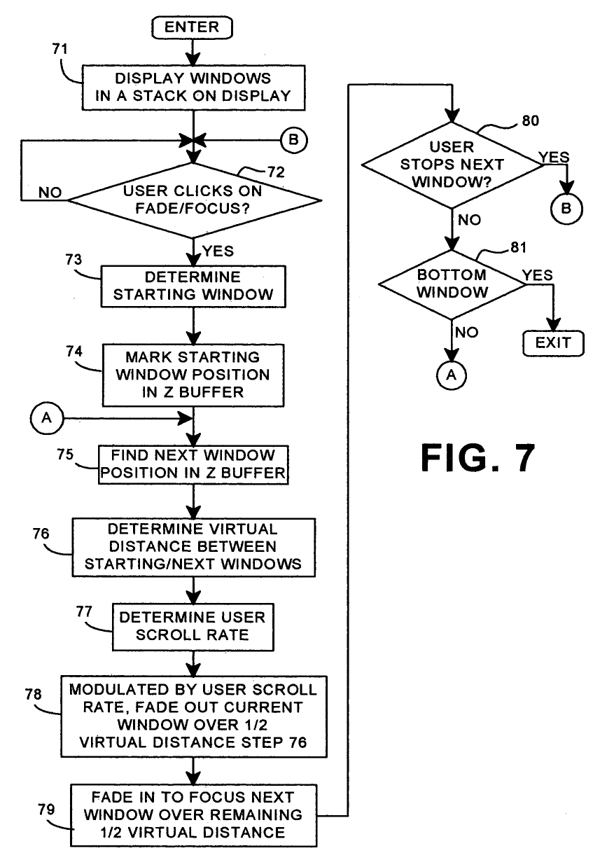

Now that the basic program has been described and illustrated, there will be described with respect to FIG. 7 a simple operation showing how the program could be run. A display is set up with a plurality of windows in a stack of overlapping windows, step 71. A determination is continually being made as to when the user clicks on a starting window with the mouse pointer or like pointer or cursor, to commence the process of the present invention, decision step 72. If Yes, the starting window is first determined, step 73, and the position of the starting window is marked in the Z order, step 74. Then, the position of the next window in the Z buffer in a downward direction is located, step 75, after which the virtual distance between the starting and next windows is determined, step 76. By sampling the scroll rate, e.g. the rate at which the user is scrolling on his mouse scroll wheel 25, FIG. 1, the scroll rate is determined, step 77. Modulated by this determined scroll rate, the fade out of the current window is carried out over half of the virtual distance, step 78, after which, the fade in to focus the next window is carried out over the remaining one-half of the virtual distance, step 79. As the next window is brought into focus by this approach, a determination is made as to whether the user wishes to stop at each window, step 79. This may be determined by the action of the user who is driving the Z motion, e.g. the user may be holding a key down, and he lets up on the key. If the user is using a scroll wheel on his mouse, then he could let up on the wheel or stop scrolling. If Yes, the user wishes to stop, the process is branched back to step 72 via branch “B”. If No, a determination is made as to whether the process has arrived at the bottom window, step 81. If Yes, the process is exited. If No, the process in then branched back to step 75 via branch “A”.

In addition, the user should be given the option when a window such as window 53 reaches the top of the stack, as in FIG. 5, then this window may be fixed in this top position. On the other hand, at this point, the whole scroll to focus action may be reversed to return to FIG. 3 where window 50 is at its initial focus position at the top of the stack.

It should also be noted that the “File” drop-down menu in FIG. 3 follows window 50 as window 50 fades in and out of focus.

Although certain preferred embodiments have been shown and described, it will be understood that many changes and modifications may be made therein without departing from the scope and intent of the appended claims.

What is claimed is:

1. In a computer controlled interactive display system comprising a stored hierarchy of windows that are displayable to overlap each other in a selected order to form a displayed stack of windows along the depth (Z) axis, a system enabling an interactive user to sort through the stack of windows in order along the Z axis comprising:
means for designating a starting window in said stack;
means for displaying said starting window in focus;
means for scrolling along said Z axis from said starting window to thereby sequentially display subsequent windows in the stack in said selected order;
means after each of said sequentially displayed windows for fading the currently displayed window out of focus; and
means, after each of said means for fading the currently displayed window, for then bringing the next subsequent window into displayed focus.

2. The computer controlled interactive display system of claim 1 wherein said scrolling is upwards from said starting window.

3. The computer controlled interactive display system of claim 1 wherein said scrolling is downwards from said starting window.

4. The computer controlled interactive display system of claim 3 further including:
a Z (depth) buffer, and
means for storing bit maps representative of the images of each of said stack of windows at depth levels in said Z buffer corresponding to the position of each window in said stack.

5. The computer controlled interactive display system of claim 4 further including:
a computer mouse for controlling a displayed pointer, said pointer designating said starting window by pointing to said window.

6. The computer controlled interactive display system of claim 5 further including:
means enabling the user to vary the rates of fading said windows out of focus and bringing subsequent windows into focus.

7. The computer controlled interactive display system of claim 6 wherein said means for fading said windows out of focus and bringing subsequent windows into focus comprises a manually controlled input on said computer mouse.

8. The computer controlled interactive display system of claim 7 wherein said manually controlled mouse input is a scroll wheel enabling the user to vary the turning of the scroll wheel to thereby vary the fadeout/bringin rates of the sequence of said windows.

9. In a computer controlled interactive display method comprising storing a hierarchy of windows that are displayable to overlap each other in a selected order to form a displayed stack of windows along the depth (Z) axis, a method enabling an interactive user to sort through the stack of windows in order along the Z axis comprising:
designating a starting window in said stack;
displaying said starting window in focus;
scrolling along said Z axis from said starting window to thereby sequentially display subsequent windows in the stack in said selected order;
fading the currently displayed window out of focus after each of said sequentially displayed windows; and
then bringing the next subsequent window into displayed focus after each of said steps of fading of the currently displayed window.

10. The computer controlled interactive display method of claim 9 wherein said scrolling is upwards from said starting window.

11. The computer controlled interactive display method of claim 9 wherein said scrolling is downwards from said starting window.

12. The computer controlled interactive display method of claim 11 further including the steps of:
controlling, though a computer mouse, a displayed pointer, designating said starting window by pointing to said window.

13. The computer controlled interactive display method of claim 12 further including the steps of:
enabling the user to vary the rates of fading said windows out of focus and bringing subsequent windows into focus.

14. A computer program having code recorded on a computer readable medium for enabling an interactive user to sort through the stack of windows in order along the Z axis in a computer controlled interactive display system comprising a stored hierarchy of windows that are displayable to overlap each other in a selected order to form a displayed stack of windows along the depth (Z) axis, said program comprising:
means for designating a starting window in said stack;
means for displaying said starting window in focus;
means for scrolling along said Z axis from said starting window to thereby sequentially display subsequent windows in the stack in said selected order;
means after each of said sequentially displayed windows for fading the currently displayed window out of focus; and
means, after each of said means for fading the currently displayed window, for then bringing the next subsequent window into displayed focus.

15. The computer program of claim 14 wherein said scrolling is upwards from said starting window.

16. The computer program of claim 14 wherein said scrolling is downwards from said starting window.

17. The computer program of claim 16 further including:
a Z (depth) buffer, and
means for storing bit maps representative of the images of each of said stack of windows at depth levels in said Z buffer corresponding to the position of each window in said stack.

18. The computer program of claim 17 further including:
a computer mouse for controlling a displayed pointer, said pointer designating said starting window by pointing to said window.

19. The computer program of claim 18 further including:
means enabling the user to vary the rates of fading said windows out of focus and bringing subsequent windows into focus.

20. The computer program of claim 19 wherein said means for fading said windows out of focus and bringing subsequent windows into focus comprises a manually controlled input on said computer mouse.
